(19) United States
(12) Patent Application Publication
(10) Pub. No.: US 2021/0179846 A1
(43) Pub. Date: Jun. 17, 2021

(54) Powder Composition For Three-Dimensional Printing Containing A Polyoxymethylene Polymer

(71) Applicant: Ticona LLC, Florence, KY (US)

(72) Inventors: Craig Peterson, Hebron, KY (US); Kirsten Markgraf, Weinheim (DE); Xiaowei Zhang, Union, KY (US)

(21) Appl. No.: 17/125,340

(22) Filed: Dec. 17, 2020

Related U.S. Application Data
(60) Provisional application No. 62/949,075, filed on Dec. 17, 2019.

(51) Int. Cl. C08L 71/02; B33Y 70/00; B29C 64/153

(52) U.S. Cl. CPC C08L 71/02; B33Y 70/00; B29K 2059/00; C08L 2205/025; B29C 64/153

(57) ABSTRACT

A polymer composition containing a polyoxymethylene polymer having low shrinkage characteristics and/or an expanded processing window is disclosed. The polymer composition is in the form of a powder containing particles having a controlled particle size and particle size distribution. The powder is formulated so as to be used in a three-dimensional printing system, such as a fused bed process.

### RELATED APPLICATIONS

The present application is based upon and claims priority to U.S. Provisional Patent Application Ser. No. 62/949,075, having a filing date of Dec. 17, 2019, which is incorporated herein by reference.

### BACKGROUND

Additive manufacturing technologies or three-dimensional printing involves various different techniques and methods to produce three-dimensional articles. Additive manufacturing technologies, for instance, includes binder jetting, directed energy deposition, material extrusion, material jetting, powder bed fusion, and the like. Powder bed fusion includes forming a three-dimensional article by formation of multiple fused layers of a powder composition. In powder bed fusing, thermal energy selectively fuses regions of the powder bed. For instance, in one embodiment, thermal energy can be provided by a laser in a process known as selective laser sintering. During selective laser sintering, a laser selectively fuses powdered material by scanning cross sections generated from a three-dimensional digital description, typically received from a computer. After each cross-section is scanned, the powder bed is typically lowered by one layer thickness, a new layer of powder material is supplied on top, and the process is repeated until a three-dimensional article is formed.

Although powder bed fusion can produce three-dimensional articles with high tolerances, problems have been experienced in the past in formulating powders that are well suited to the process. For instance, if the polymer particles have irregular shapes and sizes, the thermal requirements to fuse the particles together changes from particle to particle, resulting in non-uniformities and imperfections. In addition to particle size requirements, the polymer used to produce the powder composition should also have a relatively large operating window which will allow the particles to melt and fuse together as a heat source is scanned over the surface.

Due to the above requirements, polyoxymethylene polymers have been used sparingly in powder bed fusion processes. Although the polymers have excellent mechanical properties, fatigue resistance, abrasion resistance, and chemical resistance, the polyoxymethylene polymers can have relatively short operating windows and have high stiffness and shrinkage, which can result in cracking.

In view of the above, a need exists for a powder composition containing a polyoxymethylene polymer that is well adapted for use in forming three-dimensional articles through powder bed fusion.

### SUMMARY

The present disclosure is generally directed to a powder composition comprised of polymeric particles that contain a polyoxymethylene polymer. The powder composition is particularly formulated for use in three-dimensional printing systems, such as powder bed fusion processes. For example, the powder can have a particle size distribution and can be formulated that not only makes the powder well suited for use in being processed through a three-dimensional printing system, but also produces three-dimensional articles that have dimensional stability and are resistant to stresses and cracks that may otherwise develop from using a polyoxymethylene polymer.

For example, in one embodiment, the present disclosure is directed to a powder composition for a three-dimensional printing system that includes a sinterable powder comprised of particles having a volume based median particle size of from about 1 micron to about 200 microns. The sinterable powder is freely flowable and is comprised of a polymer composition. The polymer composition comprises a polyoxymethylene polymer in an amount greater than about 30% by weight, such as in an amount greater than about 40% by weight, such as in an amount greater than about 50% by weight, such as in an amount greater than about 60% by weight, such as in an amount greater than about 70% by weight.

In one aspect, the polyoxymethylene polymer can be a polyoxymethylene copolymer. For example, the polyoxymethylene polymer can be made with a comonomer comprising a cyclic ether, such as dioxolane. In one embodiment, the polyoxymethylene copolymer can have relatively low amounts of comonomer which has been found to dramatically improve the operating window of the polymer. For instance, the polyoxymethylene copolymer may contain the comonomer in an amount less than about 2% by weight, such as in an amount less than about 1.5% by weight, such as in an amount less than about 1.25% by weight, such as in an amount less than about 1% by weight, such as in an amount less than about 0.75% by weight, such as in an amount less than about 0.7% by weight. The comonomer content is generally greater than about 0.1% by weight, such as greater than about 0.3% by weight.

In accordance with the present disclosure, the polyoxymethylene polymer is blended with a dimensional stabilizing agent. The polymer composition displays a mold shrinkage of 1.5% or less, such as 1.3% or less, such as 1.2% or less, such as 1.1% or less, when tested according to ISO Test 294-4, 2577.

In one embodiment, the dimensional stabilizing agent may comprise an amorphous polymer. The dimensional stabilizing agent can be an elastomeric polymer. Particular dimensional stabilizing agents that may be used include a methacrylate butadiene styrene, a styrene acrylonitrile, a polycarbonate, a polyphenylene oxide, an acrylonitrile butadiene styrene, a methyl methacrylate, a polylactic acid, a copolyester elastomer, a styrene-ethylene-butylene-styrene block copolymer, a thermoplastic vulcanizate, an ethylene copolymer or terpolymer, an ethylene-propylene copolymer or terpolymer, a polyalkylene glycol, a silicone elastomer, an ethylene acrylate, a sulfonamide, high density polyethylene or mixtures thereof.

In one embodiment, the dimensional stabilizing agent comprises a thermoplastic elastomer, such as a thermoplastic polyurethane elastomer. The thermoplastic polyurethane elastomer can be present in the polymer composition in an amount from about 4% to about 40% by weight. The polymer composition can also contain a coupling agent that couples the polyoxymethylene polymer to the dimensional stabilizing agent. The coupling agent, for instance, can be a polyisocyanate. In one embodiment, the coupling agent may couple to terminal hydroxyl groups on the polyoxymethylene polymer and in turn couple to other end groups or functional groups on the dimensional stabilizing agent. The polyoxymethylene polymer, for instance, can be manufactured so as to have a relatively high content of terminal hydroxyl groups. The terminal hydroxyl groups can be present on the polyoxymethylene polymer in an amount greater than 15 mmol/kg, such as greater than about 20 mmol/kg, such as greater than about 25 mmol/kg, such as greater than about 30 mmol/kg, and generally in an amount less than about 300 mmol/kg, such as less than about 100 mmol/kg.

Through the use of one or more dimensional stabilizing agents and by selecting a polyoxymethylene polymer with particular characteristics, the polymer composition can have a crystallinity temperature and a melting temperature wherein the difference between the melting temperature and the crystallinity temperature is at least 10° C., such as at least 12° C., such as at least 14° C., such as at least 16° C., such as at least 18° C., such as at least 20° C. For instance, the melting temperature can generally be less than about 180° C. while the crystallinity temperature can generally be greater than about 130° C.

In addition to one or more dimensional stabilizing agents, the polyoxymethylene polymer can also be blended with a powder flow agent that improves the flow characteristics of the powder composition. The powder flow agent, for instance, may comprise a metal salt of a carboxylic acid. For instance, the powder flow agent can be a metal salt of a stearate, such as calcium stearate. The powder flow agent can also be a metal oxide, such as alumina particles, silica particles or mixtures thereof. The powder flow agent can be present in the polymer composition in an amount from about 2% by weight to about 25% by weight.

In one embodiment, the powder composition can further contain a filler, such as filler particles or fibers. For example, the filler can be blended with the polymeric particles to form a mixture of particles. The filler may comprise a metallic powder, metallic fibers, glass fibers, mineral fibers, mineral particles, glass beads, hollow glass beads, glass flakes, polytetrafluoroethylene particles, graphite particles, boron nitride, or mixtures thereof. When the powder composition contains a blend of filler particles and polymeric particles, the filler particles can be present in the blend in an amount from about 5% to about 60% by weight. In one aspect, a filler, such as glass fibers, can be present with a polymer additive, such as high density polyethylene particles.

The present disclosure is also directed to a printer cartridge for three-dimensional powder fusion printing. The printer cartridge contains a feed material as described above. The powder composition can be contained in a dispensing container within the printer cartridge.

The present disclosure is also directed to a three-dimensional printing system comprising a three-dimensional printing device and a printer cartridge as described above. The present disclosure is also directed to a three-dimensional article formed layer by layer in a powder bed fusion process. The present disclosure is also directed to a powder bed fusion method comprising selectively forming a three-dimensional structure from the feed material as described above.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a plan view of one embodiment of a powder bed fusion system that may be used in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

The present disclosure is generally directed to a polymer composition containing a polyoxymethylene polymer and one or more dimensional stabilizing agents. The polymer composition is in the form of a powder having a controlled particle size. The powder composition of the present disclosure is particularly well suited for use in a three-dimensional printing system, such as a powder fusion process.

The combination of the polyoxymethylene polymer with the one or more dimensional stabilizing agents produces a composition having dramatically improved properties that can be processed easier during fusion bed printing and can produce articles having better physical properties and less imperfections. The one or more dimensional stabilizing agents, for instance, can decrease the stiffness of the polyoxymethylene polymer and decrease the shrinkage properties of the polymer. The one or more dimensional stabilizing agents can also dramatically improve the operating window of the polymer. The resulting polymer composition not only can be easily processed in three-dimensional printing systems but also produces three-dimensional articles that resist cracking and have lower internal stress properties.

Powder bed fusion processes generally refer to processes where a powder is selectively sintered or melted and fused, layer-by-layer to produce a three-dimensional article. In one embodiment, the powder bed fusion process includes one or more lasers in a process known as laser sintering. During laser sintering, a laser is used to provide a pattern and heat to cause the particles to fuse or sinter together in a predetermined way. In addition to using one or more lasers as the heat source, powder bed fusion can also be achieved through the use of other forms of electromagnetic radiation, including, for example, infrared radiation, microwave energy, radiant heating lamps, and the like. The heat source can be coherent or incoherent. When using an incoherent heat source, a mask can be used in order to produce a three-dimensional article according to a particular pattern.

Three-dimensional articles formed through powder bed fusion include a plurality of overlying and adherent sintered or melted layers made from a polymer matrix. For instance, the three-dimensional article can be made from more than about 8 layers, such as more than about 10 layers, such as more than about 15 layers, such as more than about 20 layers, such as more than about 25 layers, such as more than about 30 layers, such as more than about 40 layers, such as more than about 50 layers, and generally less than about 200,000 layers, such as less than about 150,000 layers. The number of layers can depend upon the particular application and the size of the final product.

In one embodiment, a powder composition is spread over a forming surface. A heat source, such as one or more laser beams, moves relative to the powder bed for producing a pattern in the particles. In one embodiment, the pattern is computer-controlled. In order to produce the pattern, the one or more lasers can move and scan over the forming surface, the forming surface can be moved relative to the lasers, or both the forming surface and the laser can be moved simultaneously. After one layer of powder has been sintered or melted together, another layer of powder is added to the forming surface and sintered or melted repeating the process. The process repeats as the one or more lasers melt and fuse each successive layer to the previous layer until a three-dimensional article is formed.

In one embodiment, the powder composition of the present disclosure is used in a multi-jet fusion process. During multi-jet fusion, different components are combined with the powder during the printing process. For example, during a multi-jet fusion process, the powder is applied in patterns similar to the process described above. In addition to applying the powder, however, a fusing agent can also be selectively applied to the particles that are to fuse together. In addition, optionally a detailing agent can be applied selectively where the fusing action of the particles needs to be reduced or amplified. For example, the detailing agent can be used to reduce fusing at the boundary to produce a part with sharp or smooth edges. During multi-jet fusion, the three components can be applied in sequence and repeatedly to build up layers and form a part or article.

During the three-dimensional printing process, various properties of the powder composition assist in producing a product having the desired characteristics. For example, the powder composition made up of the polymeric particles is preferably flowable. The powder composition should also be sinterable, meaning that the individual polymer particles can bond together through thermal bonding or other suitable means. Consequently, formulating a polymer composition so as to have a larger operating window can facilitate particle-to-particle bonding and layer-to-layer bonding. In particular, polymer compositions that remain in a un-crystallized state over a broader temperature range are easier to process.

The polymer composition should also have dimensional stability. For instance, polymer compositions with lower shrinkage produce less internal stress during the process and produce three-dimensional articles having less imperfections and higher tolerances.

In addition to having a relatively large operating window and/or good dimensional stability, the polymer composition can also be formulated to have good flow properties when in the form of a powder. For example, the polymer composition can be formulated as a powder that has fluid-like flow properties. The powder composition can also have a controlled particle size. The particle size and/or the uniformity of the particles, for instance, can lead to the formation of articles with greater accuracy and tolerances. The powder composition of the present disclosure, for instance, can have a particle size and particle size distribution that not only leads to greater accuracy when forming three-dimensional articles but produces three-dimensional articles with improved mechanical properties.

For instance, the powder composition of the present disclosure can generally have a volume based median particle size of from about 1 micron to about 200 microns. The volume based median particle size, for instance, can be greater than about 5 microns, such as greater than about 10 microns, and generally less than about 200 microns, such as less than about 100 microns, such as less than about 70 microns, such as less than about 60 microns.

In one embodiment, for example, the powder composition can have a D50 particle size of from about 40 microns to about 70 microns, such as from about 50 microns to about 60 microns. In addition, the powder composition can have a particle size distribution such that at least about 80% of the particles, such as at least about 90% of the particles have a particle size that varies from the median particle size by no more than about 30 microns, such as by no more than about 20 microns, such as by no more than about 15 microns. In one embodiment, the powder composition can have a particle size distribution such that at least about 80% of the particles have a particle size of from about 5 microns to about 90 microns, such as from about 20 microns to about 80 microns. The presence of larger particles, for instance, can disrupt the thermal balance during formation of articles. Smaller particles, on the other hand, can lead to the presence of fines. Particle size can be determined using a laser scattering particle size distribution analyzer (e.g., Horiba LA910).

As described above, the polymer composition of the present disclosure used to produce a powder generally contains a polyoxymethylene polymer combined with one or more dimensional stabilizing agents and/or one or more powder flow agents.

The polyoxymethylene polymer incorporated into the polymer composition can comprise a polyoxymethylene homopolymer or a polyoxymethylene copolymer.

The preparation of the polyoxymethylene polymer can be carried out by polymerization of polyoxymethylene-forming monomers, such as trioxane or a mixture of trioxane and a cyclic acetal such as dioxolane in the presence of a molecular weight regulator, such as a glycol. According to one embodiment, the polyoxymethylene is a homo- or copolymer which comprises at least 50 mol. %, such as at least 75 mol. %, such as at least 90 mol. % and such as even at least 97 mol. % of —CH₂O-repeat units.

In one embodiment, a polyoxymethylene copolymer is used. The copolymer can contain from about 0.1 mol. % to about 20 mol. % and in particular from about 0.5 mol. % to about 10 mol. % of repeat units that comprise a saturated or ethylenically unsaturated alkylene group having at least 2 carbon atoms, or a cycloalkylene group, which has sulfur atoms or oxygen atoms in the chain and may include one or more substituents selected from the group consisting of alkyl cycloalkyl, aryl, aralkyl, heteroaryl, halogen or alkoxy. In one embodiment, a cyclic ether or acetal is used that can be introduced into the copolymer via a ring-opening reaction.

Preferred cyclic ethers or acetals are those of the formula:

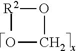

in which x is 0 or 1 and R² is a C₂-C₄-alkylene group which, if appropriate, has one or more substituents which are C₁-C₄-akyl groups, or are C₁-C₅₄-alkoxy groups, and/or are halogen atoms, preferably chlorine atoms. Merely by way of example, mention may be made of ethylene oxide, propylene 1,2-oxide, butylene 1,2-oxide, butylene 1,3-oxide, 1,3-dioxane, 1,3-dioxolane, and 1,3-dioxepan as cyclic ethers, and also of linear oligo- or polyformals, such as polydioxolane or polydioxepan, as comonomers. It is particularly advantageous to use copolymers composed of from 99.5 to 95 mol. % of trioxane and of from 0.5 to 5 mol. %, such as from 0.5 to 4 mol. %, of one of the above-mentioned comonomers.

In one particular aspect of the present disclosure, the polyoxymethylene copolymer incorporated into the powder composition contains a relatively low amount of comonomer. For example, the polyoxymethylene copolymer can contain a comonomer, such as dioxolane, in an amount less than about 2% by weight, such as in an amount less than about 1.5% by weight, such as in an amount less than about 1.25% by weight, such as in an amount less than about 1% by weight, such as in an amount less than about 0.75% by weight, such as in an amount less than about 0.7% by weight. The comonomer content is generally greater than about 0.3% by weight, such as greater than about 0.5% by weight. It was unexpectedly discovered that maintaining low comonomer content in the polyoxymethylene polymer can dramatically increase the operating window of the polymer composition.

The polymerization can be effected as precipitation polymerization or in the melt. By a suitable choice of the polymerization parameters, such as duration of polymerization or amount of molecular weight regulator, the molecular weight and hence the MVR value of the resulting polymer can be adjusted.

Although any suitable polyoxymethylene polymer may be used, in one embodiment, the polyoxymethylene polymer used in the polymer composition may contain a relatively high amount of reactive groups or functional groups in the terminal position. The reactive groups or functional groups, for instance, can help compatibilize the polyoxymethylene polymer with the one or more dimensional stabilizing agents and/or with one or more other components that may be contained in the polymer composition. The reactive groups, for instance, may comprise —OH or —NH₂ groups.

In one embodiment, the polyoxymethylene polymer can have terminal hydroxyl groups, for example hydroxyethylene groups and/or hydroxyl side groups, on at least more than about 50% of all the terminal sites on the polymer. For instance, the polyoxymethylene polymer may have at least about 70%, such as at least about 80%, such as at least about 85% of its terminal groups be hydroxyl groups, based on the total number of terminal groups present. It should be understood that the total number of terminal groups present includes all side terminal groups.

In one embodiment, the polyoxymethylene polymer has a content of terminal hydroxyl groups of at least 15 mmol/kg, such as at least 18 mmol/kg, such as at least 20 mmol/kg, such as greater than about 25 mmol/kg, such as greater than about 30 mmol/kg, such as greater than about 40 mmol/kg, such as greater than about 50 mmol/kg. The terminal hydroxyl content is generally less than about 300 mmol/kg, such as less than about 200 mmol/kg, such as less than about 100 mmol/kg. In one embodiment, the terminal hydroxyl group content ranges from 18 to 50 mmol/kg. In an alternative embodiment, the polyoxymethylene polymer may contain terminal hydroxyl groups in an amount less than 20 mmol/kg, such as less than 18 mmol/kg, such as less than 15 mmol/kg. For instance, the polyoxymethylene polymer may contain terminal hydroxyl groups in an amount from about 5 mmol/kg to about 20 mmol/kg, such as from about 5 mmol/kg to about 15 mmol/kg. For example, a polyoxymethylene polymer may be used that has a lower terminal hydroxyl group content but has a higher melt volume flow rate. The quantification of the hydroxyl group content in the polyoxymethylene polymer may be conducted by the method described in JP-A-2001-11143.

In addition to the terminal hydroxyl groups, the polyoxymethylene polymer may also have other terminal groups usual for these polymers. Examples of these are alkoxy groups, formate groups, acetate groups or aldehyde groups. According to one embodiment, the polyoxymethylene is a homo- or copolymer which comprises at least 50 mol-%, such as at least 75 mol-%, such as at least 90 mol-% and such as even at least 95 mol-% of —CH₂O-repeat units.

In one embodiment, a polyoxymethylene polymer with hydroxyl terminal groups can be produced using a cationic polymerization process followed by solution hydrolysis to remove any unstable end groups. During cationic polymerization, a glycol, such as ethylene glycol can be used as a chain terminating agent. The cationic polymerization can result in a bimodal molecular weight distribution containing low molecular weight constituents. In one particular embodiment, the low molecular weight constituents can be significantly reduced by conducting the polymerization using a heteropoly acid such as phosphotungstic acid as the catalyst. When using a heteropoly acid as the catalyst, for instance, the amount of low molecular weight constituents can be less than about 2 wt. %.

The polyoxymethylene polymer can have any suitable molecular weight. The molecular weight of the polymer, for instance, can be from about 4,000 grams per mole to about 20,000 g/mol. In other embodiments, however, the molecular weight can be well above 20,000 g/mol, such as from about 20,000 g/mol to about 100,000 g/mol.

The polyoxymethylene polymer present in the composition can generally have a melt flow index (MFI) ranging from about 1 to about 200 g/10 min, as determined according to ISO 1133 at 190° C. and 2.16 kg, though polyoxymethylenes having a higher or lower melt flow index are also encompassed herein. For example, the polyoxymethylene polymer may have a melt flow index of greater than about 5 g/10 min, such as greater than about 10 g/10 min, such as greater than about 20 g/10 min, such as greater than about 30 g/10 min, such as greater than about 40 g/10 min, such as greater than about 50 g/10 min, such as greater than about 60 g/10 min, such as greater than about 70 g/10 min. The melt flow index of the polyoxymethylene polymer can be less than about 150 g/10 min, less than about 100 g/10 min, less than about 50 g/10 min, less than about 30 g/10 min, less than about 15 g/10 min, or less than about 12 g/10 min. In one embodiment, the polyoxymethylene polymer can have a melt flow index of greater than about 40 g/10 min, such as greater than about 45 g/10 min, such as greater than about 50 g/10 min, and generally less than about 80 g/10 min, such as less than about 70 g/10 min.

The polyoxymethylene polymer may be present in the polyoxymethylene polymer composition in an amount of at least 30 wt. %, such as at least 40 wt. %, such as at least 50 wt. %, such as at least 60 wt. %, such as at least 70 wt. %, such as at least 80 wt. %. In one embodiment, the polyoxymethylene polymer composition can contain almost exclusively the polyoxymethylene polymer. For example, the polyoxymethylene polymer can be present in an amount greater than about 90% by weight, such as in an amount greater than about 95% by weight, such as in an amount greater than about 96% by weight, such as in an amount greater than about 97% by weight, such as in an amount greater than about 98% by weight, such as in an amount greater than about 99% by weight.

In accordance with the present disclosure, the polyoxymethylene polymer is combined with one or more dimensional stabilizing agents. The dimensional stabilizing agent, for instance, may comprise a polymer component.

Polymers that can serve as the dimensional stabilizing agent include amorphous polymers or semi-crystalline polymers. Examples of dimensional stabilizing agents in polymer form include a methacrylate butadiene styrene, a styrene acrylonitrile, a polycarbonate, a polyphenylene oxide, an acrylonitrile butadiene styrene, a methyl methacrylate, a polylactic acid, a copolyester elastomer, a styrene ethylene butylene styrene block copolymer, a thermoplastic vulcanizate, an ethylene copolymer or terpolymer, an ethylene propylene copolymer or terpolymer, a silicone elastomer, an ethylene acrylate, a sulfonamide, a high density polyethylene or mixtures thereof.

In one embodiment, the dimensional stabilizing agent is a thermoplastic elastomer. Thermoplastic elastomers well suited for use in the present disclosure are polyester elastomers (TPE-E), thermoplastic polyamide elastomers (TPE-A) and in particular thermoplastic polyurethane elastomers (TPE-U). The above thermoplastic elastomers have active hydrogen atoms which can be reacted with a coupling reagent and/or the polyoxymethylene polymer. Examples of such groups are urethane groups, amido groups, amino groups or hydroxyl groups. For instance, terminal polyester diol flexible segments of thermoplastic polyurethane elastomers have hydrogen atoms which can react, for example, with isocyanate groups.

In one particular embodiment, a thermoplastic polyurethane elastomer is used as the dimensional stabilizing agent either alone or in combination with other dimensional stabilizing agents. The thermoplastic polyurethane elastomer, for instance, may have a soft segment of a long-chain dial and a hard segment derived from a diisocyanate and a chain extender. In one embodiment, the polyurethane elastomer is a polyester type prepared by reacting a long-chain diol with a diisocyanate to produce a polyurethane prepolymer having isocyanate end groups, followed by chain extension of the prepolymer with a diol chain extender. Representative long-chain diols are polyester diols such as poly(butylene adipate)diol, polyethylene adipate)diol and poly(E-caprolactone)diol; and polyether diols such as poly(tetramethylene ether)glycol, poly(propylene oxide)glycol and poly(ethylene oxide)glycol. Suitable diisocyanates include 4,4′-methylenebis(phenyl isocyanate), 2,4-toluene diisocyanate, 1,6-hexamethylene diisocyanate and 4,4′-methylenebis-(cycloxylisocyanate). Suitable chain extenders are C₂-C₆ aliphatic dials such as ethylene glycol, 1,4-butanediol, 1,6-hexanedial and neopentyl glycol. One example of a thermoplastic polyurethane is characterized as essentially poly(adipic acid-co-butylene glycol-co-diphenylmethane diisocyanate).

The thermoplastic elastomer may be present in the composition in an amount greater than about 10% by weight and in an amount less than about 60% by weight. For instance, the thermoplastic elastomer may be present in an amount from about 15% to about 25% by weight.

In an alternative embodiment, the dimensional stabilizing agent may comprise a non-aromatic polymer, which refers to a polymer that does not include any aromatic groups on the backbone of the polymer. Such polymers include acrylate polymers and/or graft copolymers containing an olefin. For instance, an olefin polymer can serve as a graft base and can be grafted to at least one vinyl polymer or one ether polymer. In still another embodiment, the graft copolymer can have an elastomeric core based on polydienes and a hard or soft graft envelope composed of a (meth)acrylate and/or a (meth)acrylonitrile.

Examples of dimensional stabilizing agents as described above include ethylene-acrylic acid copolymer, ethylene-maleic anhydride copolymers, ethylene-alkyl(meth)acrylate-maleic anhydride terpolymers, ethylene-alkyl(meth)acrylate-glycidyl(meth)acrylate terpolymers, ethylene-acrylic ester-methacrylic acid terpolymer, ethylene-acrylic ester-maleic anhydride terpolymer, ethylene-methacrylic acid-methacrylic acid alkaline metal salt (ionomer) terpolymers, and the like. In one embodiment, for instance, a dimensional stabilizing agent can include a random terpolymer of ethylene, methylacrylate, and glycidyl methacrylate. The terpolymer can have a glycidyl methacrylate content of from about 5% to about 20%, such as from about 6% to about 10%. The terpolymer may have a methylacrylate content of from about 20% to about 30%, such as about 24%.

The dimensional stabilizing agent may be a linear or branched, homopolymer or copolymer (e.g., random, graft, block, etc.) containing epoxy functionalization, e.g., terminal epoxy groups, skeletal oxirane units, and/or pendent epoxy groups. For instance, the dimensional stabilizing agent may be a copolymer including at least one monomer component that includes epoxy functionalization. The monomer units of the dimensional stabilizing agent may vary. For example, the dimensional stabilizing agent can include epoxy-functional methacrylic monomer units. As used herein, the term methacrylic generally refers to both acrylic and methacrylic monomers, as well as salts and esters thereof, e.g., acrylate and methacrylate monomers. Epoxy-functional methacrylic monomers as may be incorporated in the dimensional stabilizing agent may include, but are not limited to, those containing 1,2-epoxy groups, such as glycidyl acrylate and glycidyl methacrylate. Other suitable epoxy-functional monomers include allyl glycidyl ether, glycidyl ethacrylate, and glycidyl itoconate.

Examples of other monomers may include, for example, ester monomers, olefin monomers, amide monomers, etc. In one embodiment, the dimensional stabilizing agent can include at least one linear or branched a-olefin monomer, such as those having from 2 to 20 carbon atoms, or from 2 to 8 carbon atoms. Specific examples include ethylene; propylene; 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene.

In one embodiment, the dimensional stabilizing agent can be a terpolymer that includes epoxy functionalization. For instance, the dimensional stabilizing agent can include a methacrylic component that includes epoxy functionalization, an a-olefin component, and a methacrylic component that does not include epoxy functionalization. For example, the dimensional stabilizing agent may be poly(ethylene-co-methylacrylate-co-glycidyl methacrylate), which has the following structure:

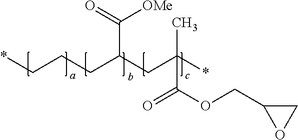

wherein, a, b, and c are 1 or greater.

In another embodiment the dimensional stabilizing agent can be a random copolymer of ethylene, ethyl acrylate and maleic anhydride having the following structure:

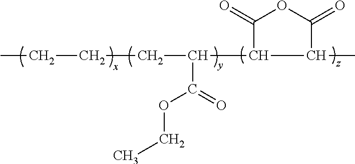

wherein x, y and z are 1 or greater.

The relative proportion of the various monomer components of a copolymeric dimensional stabilizing agent is not particularly limited. For instance, in one embodiment, the epoxy-functional methacrylic monomer components can form from about 1 wt. % to about 25 wt. %, or from about 2 wt. % to about 20 wt % of a copolymeric dimensional stabilizing agent. An a-olefin monomer can form from about 55 wt. % to about 95 wt. %, or from about 60 wt. % to about 90 wt. %, of a copolymeric dimensional stabilizing agent. When employed, other monomeric components (e.g., a non-epoxy functional methacrylic monomers) may constitute from about 5 wt. % to about 35 wt. %, or from about 8 wt. % to about 30 wt. %, of a copolymeric dimensional stabilizing agent.

The molecular weight of the above dimensional stabilizing agent can vary widely. For example, the dimensional stabilizing agent can have a number average molecular weight from about 7,500 to about 250,000 grams per mole, in some embodiments from about 15,000 to about 150,000 grams per mole, and in some embodiments, from about 20,000 to 100,000 grams per mole, with a polydispersity index typically ranging from 2.5 to 7.

The above dimensional stabilizing agent may be present in the composition in varying amounts depending on the application. For instance, the dimensional stabilizing agent can be present in an amount of 5% or greater of the thermoplastic composition, for instance from 15% to about 40% by weight, from about 18% to about 37% by weight, or from about 20% to about 35% by weight in some embodiments.

Other dimensional stabilizing agents that may be used in accordance with the present disclosure include polyepoxides, polyurethanes, polybutadiene, acrylonitrile-butadiene-styrene, polysiloxanes, polyamides, block copolymers (e.g., polyether-polyamide block copolymers), etc., as well as mixtures thereof.

In one particular embodiment, the dimensional stabilizing agent may include a polyepoxide that contains at least two oxirane rings per molecule. The polyepoxide may be a linear or branched, homopolymer or copolymer (e.g., random, graft, block, etc.) containing terminal epoxy groups, skeletal oxirane units, and/or pendent epoxy groups. The monomers employed to form such polyepoxides may vary. In one particular embodiment, for example, the polyepoxide modifier contains at least one epoxy-functional (meth)acrylic monomeric component. The term “(meth)acrylic” includes acrylic and methacrylic monomers, as well as salts or esters thereof, such as acrylate and methacrylate monomers. Suitable epoxy-functional (meth)acrylic monomers may include, but are not limited to, those containing 1,2-epoxy groups, such as glycidyl acrylate and glycidyl methacrylate. Other suitable epoxy-functional monomers include allyl glycidyl ether, glycidyl ethacrylate, and glycidyl itoconate.

In yet another embodiment, the dimensional stabilizing agent may include a block copolymer in which at least one phase is made of a material that is hard at room temperature but fluid upon heating and another phase is a softer material that is rubber-like at room temperature. For instance, the block copolymer may have an A-B or A-B-A block copolymer repeating structure, where A represents hard segments and B is a soft segment. Non-limiting examples of dimensional stabilizing agents having an A-B repeating structure include polyamide/polyether, polysulfone/polydimethylsiloxane, polyurethane/polyester, polyurethane/polyether, polyester/polyether, polycarbonate/polydimethylsiloxane, and polycarbonate/polyether. Triblock copolymers may likewise contain polystyrene as the hard segment and either polybutadiene, polyisoprene, or polyethylene-co-butylene as the soft segment. Similarly, styrene butadiene repeating co-polymers may be employed, as well as polystyrene/polyisoprene repeating polymers. In one particular embodiment, the block copolymer may have alternating blocks of polyamide and polyether. The polyamide blocks may be derived from a copolymer of a diacid component and a diamine component, or may be prepared by homopolymerization of a cyclic lactam. The polyether block may be derived from homo- or copolymers of cyclic ethers such as ethylene oxide, propylene oxide, and tetrahydrofuran.

In one embodiment, a triblock copolymer may be used as the dimensional stabilizing agent. For instance, the triblock copolymer may comprise a styrene ethylene butylene styrene (SEBS) block copolymer.

In still another embodiment, the dimensional stabilizing agent may comprise a silicone elastomer.

Illustrative silicone elastomers may comprise polydiorganosiloxanes such as polydimethylsiloxane. For example, a silicone elastomer can be a polydimethylsiloxane that can be terminated with, e.g., hydroxyl, or vinyl functionality. In one embodiment, the silicone elastomer can include at least 2 alkenyl groups having 2 to 20 carbon atoms. The alkenyl group can include, for example, vinyl, allyl, butenyl, pentenyl, hexenyl and decenyl. The position of the alkenyl functionality is not critical and it may be bonded at the molecular chain terminals, in non-terminal positions on the molecular chain, or at both positions. In general, the alkenyl functionality can be present at a level of 0.001 to 3 weight percent, preferably 0.01 to 1 weight percent, of the silicone elastomer. In one embodiment, the silicone elastomer dimensional stabilizing agent is a polydimethylsiloxane homopolymer that is terminated with a hydroxyl or a vinyl group at each end and optionally that also contains at least one vinyl group along its main chain.

Other organic groups of the silicone elastomer dimensional stabilizing agent can be independently selected from hydrocarbon or halogenated hydrocarbon groups that contain no aliphatic unsaturation. These can be exemplified by alkyl groups having 1 to 20 carbon atoms, such as methyl, ethyl, propyl, butyl, pentyl and hexyl; cycloalkyl groups, such as cyclohexyl and cycloheptyl; and halogenated alkyl groups having 1 to 20 carbon atoms, such as 3,3,3-trifluoropropyl and chloromethyl. It will be understood that these groups are selected such that the silicone elastomer has a glass transition temperature (or melt point) that is below room temperature and as such is therefore elastomeric.

The silicone elastomer dimensional stabilizing agent can be a homopolymer or a copolymer. The molecular structure is also not critical and is exemplified by straight-chain and partially branched straight-chains.

Specific illustrations of silicone elastomer non-aromatic dimensional stabilizing agents can include, without limitation, trimethylsiloxy-endblocked dimethylsiloxane-methylhexenylsiloxane copolymers; dimethylhexenlylsiloxy-endblocked dimethylsiloxane-methylhexenylsiloxane copolymers; trimethylsiloxy-endblocked dimethylsiloxane-methylvinylsiloxane copolymers; dimethylvinylsiloxy-endblocked dimethylsiloxane-methylvinylsiloxane copolymers; and similar copolymers wherein at least one end group is dimethylhydroxysiloxy.

In one aspect, the dimensional stabilizing agent is a polyalkylene glycol. Polyalkylene glycols particularly well suited for use in the polymer composition include polyethylene glycols, polypropylene glycols, and mixtures thereof. For example, in one embodiment, the dimensional stabilizing agent incorporated into the polymer composition is a polyethylene glycol.

The molecular weight of the polyalkylene glycol can vary depending upon various factors including the characteristics of the polyoxymethylene polymer and the process conditions for producing shaped articles. In one aspect, the polyalkylene glycol, such as the polyethylene glycol, can have a relatively low molecular weight. For example, the molecular weight can be less than about 10,000 g/mol, such as less than about 8,000 g/mol, such as less than about 6,000 g/mol, such as less than about 4,000 g/mol, and generally greater than about 1000 g/mol, such as greater than about 2000 g/mol. In one embodiment, a polyethylene glycol plasticizer is incorporated into the polymer composition that has a molecular weight of from about 2000 g/mol to about 5000 g/mol.

In another aspect, a polyalkylene glycol, such as the polyethylene glycol, can be selected that has a higher molecular weight. For example, the molecular weight of the polyalkylene glycol can be about 10,000 g/mol or greater, such as greater than about 20,000 g/mol, such as greater than about 30,000 g/mol, such as greater than about 35,000 g/mol, and generally less than about 100,000 g/mol, such as less than about 50,000 g/mol, such as less than about 45,000 g/mol, such as less than about 40,000 g/mol.

In another aspect, the dimensional stabilizing agent are high density polyethylene particles, such as ultrahigh-molecular-weight polyethylene (UHMW-PE) particles. For example, from 0.1-50 wt. %, such as from 1-25 wt. %, such as from 2.5-20 wt. %, such as from 5 to 15 wt. %, of an ultrahigh-molecular-weight polyethylene (UHMW-PE) powder can be added to the polymer composition. UHMW-PE can be employed as a powder, in particular as a micro-powder. The UHMW-PE generally has a mean particle diameter D50 (volume based and determined by light scattering) in the range of 1 to 5000μm, preferably from 10 to 500μm, and particularly preferably from 10 to 150μm such as from 30 to 130μm, such as from 80 to 150μm, such as from 30 to 90μm.

The UHMW-PE can have an average molecular weight of higher than about 300,000 g/mol, such as greater than about 500,000 g/mol, such as greater than about 1.0·106 g/mol, such as higher than 2.0·106 g/mol, such as higher than 4.0·106 g/mol, such as ranging from 1.0·106 g/mol to 15.0·106 g/mol, such as from 3.0·106 g/mol to 12.0·106 g/mol, determined by viscosimetry and the Margolies equation. The viscosity number of the UHMW-PE is higher than 1000 ml/g, such as higher than 1500 ml/g, such as ranging from 1800 ml/g to 5000 ml/g, such as ranging from 2000 ml/g to 4300 ml/g (determined according to ISO 1628, part 3; concentration in decahydronaphthalin: 0.0002 g/ml).

In another aspect, the dimensional stabilizing agent is a sulfonamide. In one aspect, the sulfonamide can be an ortho-para-toluene sulfonamide (35-45% ortho content). The toluene sulfonamide can have a relatively low melting point. For instance, the melting point of the sulfonamide can be less than about 120° C., such as less than about 115° C. The melting point is generally greater than about 50° C., such as greater than about 60° C., such as greater than about 75° C. The toluene sulfonamide can be in the form of a solid when combined with the other ingredients. In another aspect, the sulfonamide can be is an aromatic benzene sulfonamide represented by the general formula (I):

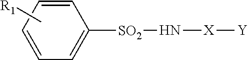

in which R1 represents a hydrogen atom, a C1-C4 alkyl group or a C1-C4 alkoxy group, X represents a linear or branched C2-C10 alkylene group, or an alkyl group, or a methylene group, or a cycloaliphatic group, or an aromatic group, and Y represents one of the groups H, OH or

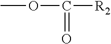

in which R2 represents a C1-C4 alkyl group or an aromatic group, these groups optionally themselves being substituted by an OH or C1-C4 alkyl group.

The preferred aromatic benzenesulphonamides of formula (I) are those in which: R1 represents a hydrogen atom or a methyl or methoxy group, X represents a linear or branched C2-C10 alkylene group or a phenyl group, Y represents an H, OH or —O—CO13 R2 group, R2 representing a methyl or phenyl group, the latter being themselves optionally substituted by an OH or methyl group.

Mention may be made, among the aromatic sulphonamides of formula (I) which are liquid (L) or solid (S) at room temperature as specified below, of the following products, with the abbreviations which have been assigned to them:
N-(2-hydroxyethyl)benzenesulphonamide (L),
N-(3-hydroxypropyl)benzenesulphonamide (L),
N-(2-hydroxyethyl)-p-toluenesulphonamide (S),
N-(4-hydroxyphenyl)benzenesulphonamide (S),
N-[(2-hydroxy-1-hydroxymethyl-1-methyl)ethyl]benzenesulphonamide (L),
N-[5-hydroxy-1,5-dimethylhexyl]benzenesulphonamide (S),
N-(2-acetoxyethyl)benzenesulphonamide (S),
N-(5-hydroxypentyl)benzenesulphonamide (L),
N-[2-(4-hydroxybenzoyloxy)ethyl]benzene-sulphonamide (S),
N-[2-(4-methylbenzoyloxy)ethyl]benzenesulphonamide (S),
N-(2-hydroxyethyl)-p-methoxybenzenesulphonamide (S) and
N-(2-hydroxypropyl)benzenesulphonamide (L).
One particular sulfonamide, for example, is N-(n-butyl)benzene sulfonamide.

When the dimensional stabilizing agent comprises a polymer component, the dimensional stabilizing agent can be present in the polymer composition (in addition to amounts provided above) in an amount generally greater than about 3% by weight, such as in an amount greater than about 5% by weight, such as in an amount greater than about 8% by weight, such as in an amount greater than about 10% by weight, such as in an amount greater than about 12% by weight, such as in an amount greater than about 15% by weight, and generally less than about 60% by weight, such as less than about 40% by weight, such as less than about 30% by weight, such as less than about 25% by weight.

In one embodiment, in addition to one or more dimensional stabilizing agents, the polymer composition can contain a coupling agent. The coupling agent can be used to compatibilize the different components. For instance, the coupling agent can couple to the polyoxymethylene polymer and to the one or more dimensional stabilizing agents.

In one embodiment, the coupling agent comprises a polyisocyanate, such as a diisocyanate, such as an aliphatic, cycloaliphatic and/or aromatic diisocyanate. The coupling agent may be in the form of an oligomer, such as a trimer or a dimer.

In one embodiment, the coupling agent comprises a diisocyanate or a triisocyanate which is selected from 2,2′-, 2,4′-, and 4,4′-diphenylmethane diisocyanate (MDI); 3,3′-dimethyl-4,4′-biphenylene diisocyanate (TODD; toluene diisocyanate (TDI); polymeric MDI; carbodiimide-modified liquid 4,4′-diphenylmethane diisocyanate; para-phenylene diisocyanate (PPDI); meta-phenylene diisocyanate (MPDI); triphenyl methane-4,4′- and triphenyl methane-4,4″-triisocyanate; naphthylene-1,5-diisocyanate; 2,4′-, 4,4′-, and 2,2-biphenyl diisocyanate; polyphenylene polymethylene polyisocyanate (PMDI) (also known as polymeric PMDI); mixtures of MDI and PMDI; mixtures of PMDI and TDI; ethylene diisocyanate; propylene-1,2-diisocyanate; trimethylene diisocyanate; butylenes diisocyanate; bitolylene diisocyanate; tolidine diisocyanate; tetramethylene-1, 2-diisocyanate; tetramethylene-1,3-diisocyanate; tetramethylene-1,4-diisocyanate; pentamethylene diisocyanate; 1,6-hexamethylene diisocyanate (HDI); octamethylene diisocyanate; decamethylene diisocyanate; 2,2,4-trimethylhexamethylene diisocyanate; 2,4,4-trimethylhexamethylene diisocyanate; dodecane-1,12-diisocyanate; dicyclohexylmethane diisocyanate; cyclobutane-1,3-diisocyanate; cyclohexane-1,2-diisocyanate; cyclohexane-1,3-diisocyanate; cyclohexane-1,4-diisocyanate; diethylidene diisocyanate; methylcyclohexylene diisocyanate (HTDI); 2,4-methylcyclohexane diisocyanate; 2,6-methylcyclohexane diisocyanate; 4,4′-dicyclohexyl diisocyanate; 2,4′-dicyclohexyl diisocyanate; 1,3,5-cyclohexane triisocyanate; isocyanatomethylcyclohexane isocyanate; 1-isocyanato-3,3,5-trimethyl-5-isocyanatomethylcyclohexane; isocyanatoethylcyclohexane isocyanate; bis(isocyanatomethyl)-cyclohexane diisocyanate; 4,4′-bis(isocyanatomethyl) dicyclohexane; 2,4′-bis(isocyanatomethyl) dicyclohexane; isophorone diisocyanate (IPDI); dimeryl diisocyanate, dodecane-1,12-diisocyanate, 1,10-decamethylene diisocyanate, cyclohexylene-1,2-diisocyanate, 1,10-decamethylene diisocyanate, 1-chlorobenzene-2, 4-diisocyanate, furfurylidene diisocyanate, 2,4,4-trimethyl hexamethylene diisocyanate, 2,2,4-trimethyl hexamethylene diisocyanate, dodecamethylene diisocyanate, 1,3-cyclopentane diisocyanate, 1,3-cyclohexane diisocyanate, 1,3-cyclobutane diisocyanate, 1,4-cyclohexane diisocyanate, 4,4′-methylenebis(cyclohexyl isocyanate), 4,4′-methylenebis(phenyl isocyanate), 1-methyl-2,4-cyclohexane diisocyanate, 1-methyl-2,6-cyclohexane diisocyanate, 1,3-bis(isocyanato-methyl)cyclohexane, 1,6-diisocyanato-2,2,4,4-tetra-methylhexane, 1,6-diisocyanato-2,4,4-tetra-trimethylhexane, trans-cyclohexane-1,4-diisocyanate, 3-isocyanato-methyl-3,5,5-trimethylcyclo-hexyl isocyanate, 1-isocyanato-3,3,5-trimethyl-5-isocyanatomethylcyclohexane, cyclo-hexyl isocyanate, dicyclohexylmethane 4,4′-diisocyanate, 1,4-bis(isocyanatomethyl)cyclohexane, m-phenylene diisocyanate, m-xylylene diisocyanate, m-tetramethylxylylene diisocyanate, p-phenylene diisocyanate, p,p′-biphenyl diisocyanate, 3,3′-dimethyl-4,4′-biphenylene diisocyanate, 3,3′-dimethoxy-4,4′-biphenylene diisocyanate, 3,3′-diphenyl-4,4′-biphenylene diisocyanate, 4,4′-biphenylene diisocyanate, 3,3′-dichloro-4,4′-biphenylene diisocyanate, 1,5-naphthalene diisocyanate, 4-chloro-1,3-phenylene diisocyanate, 1,5-tetrahydronaphthalene diisocyanate, metaxylene diisocyanate, 2,4-toluene diisocyanate, 2,4′-diphenylmethane diisocyanate, 2,4-chlorophenylene diisocyanate, 4,4′-diphenylmethane diisocyanate, p,p′-diphenylmethane diisocyanate, 2,4-tolylene diisocyanate, 2,6-tolylene diisocyanate, 2,2-diphenylpropane-4,4′-diisocyanate, 4,4′-toluidine diisocyanate, dianidine diisocyanate, 4,4′-diphenyl ether diisocyanate, 1,3-xylylene diisocyanate, 1,4-naphthylene diisocyanate, azobenzene-4,4′-diisocyanate, diphenyl sulfone-4,4′-diisocyanate, or mixtures thereof.

In one embodiment, an aromatic polyisocyanate is used, such as 4,4′-diphenylmethane diisocyanate (MDI).

When present, the coupling agent can be present in the composition in an amount generally from about 0.1% to about 5% by weight. In one embodiment, for instance, the coupling agent can be present in an amount from about 0.1% to about 2% by weight, such as from about 0.2% to about 1% by weight. In an alternative embodiment, the coupling agent can be added to the polymer composition in molar excess amounts when comparing the reactive groups on the coupling agent with the amount of functional groups on the polyoxymethylene polymer.

In addition to one or more dimensional stabilizing agents, the polymer composition can also contain a powder flow agent. The powder flow agent can be added to the polymer composition so that the powder has fluid-like flow properties and that the individual particles do not stick or agglomerate together.

Powder flow agents which may be used, individually or in combination, are metal oxides, polyalkylene oxides, such as polyethylene glycol (PEG), alkali-metal or alkaline-earth-metal salts or salts of other bivalent metal ions, such as Zn²⁺, of long-chain fatty acids, such as stearates, laurates, oleates, behenates, montanates and palmitates, and also amide waxes, montan waxes or olefin waxes. High-molecular-weight polyalkylene oxides that may be used include polyethylene glycol with a molecular weight above 25,000, amide waxes, montan waxes or olefin waxes.

In one aspect, the powder flow agent can be a metal oxide or a metal salt of a carboxylic acid, such as an alkali-metal salt or an alkaline-earth-metal salt of a carboxylic acid. The carboxylic acid, for instance, may be a stearate. For example, in one aspect, the powder flow agent is calcium stearate. Metal oxide particles that can be used as powder flow agents include aluminum oxide, silicon dioxide, and mixtures thereof. The alumina and silica can be fumed alumina and fumed silica. The d50 particle size of the metal oxide can be from about 1 micron to about 25 microns, such as from about 5 microns to about 18 microns, determined using laser diffraction according to ISO Test 13320.

When present, the powder flow agent can be added to the polymer composition and incorporated into the individual particles in an amount greater than about 2% by weight, such as in an amount greater than about 4% by weight, such as in an amount greater than about 6% by weight, such as in an amount greater than about 8% by weight and generally in an amount less than about 25% by weight, such as in an amount less than about 20% by weight, such as in an amount less than about 15% by weight, such as in an amount less than about 12% by weight.

The polymer composition of the present disclosure can also optionally contain a stabilizer and/or various other additives. Such additives can include, for example, antioxidants, acid scavengers, UV stabilizers or heat stabilizers. In addition, the polymer composition may contain processing auxiliaries, for example adhesion promoters, or antistatic agents.

For instance, in one embodiment, an ultraviolet light stabilizer may be present. The ultraviolet light stabilizer may comprise a benzophenone, a benzotriazole, or a benzoate. Particular examples of ultraviolet light stabilizers include 2,4-dihydroxy benzophenone, 2-hydroxy-4-methoxybenzophenone, 2-(2′-hydroxy-3′,5′-di-t-butylphenyl)benzotriazole, 2-(2′-hydroxy-3′-t-butyl-5′-methylphenyl)-5-chlorobenzotriazole, 2,4-dihydroxybenzophenone, 2-hydroxy-4-methoxybenzophenone, 2-hydroxy-4-octoxybenzophenone, and 5,5′-methylene bis(2-hydroxy-4-methoxybenzophenone); 2-(2′-hydroxyphenyl)benzotriazoles, e.g., 2-(2′-hydroxy-5′-methylphenyl)benzotriazole, 2-(2′-hydroxy-5-t-octylphenyl)benzotriazole, 2-(2′-hydroxy-3′,5′-di-t-butylphenyl)benzotriazole, 2-(2′-hydroxy-3′,5′-di-t-butylphenyl)-5-chlorobenzotriazole, 2-(2′-hydroxy-3′-t-butyl-5′-methylphenyl)-5-chlorobenzotriazole, 2-(2′-hydroxy-3′,5′-dicumylphenyl)benzotriazole, and 2,2′-methylene bis(4-t-octyl-6-benzotriazolyl)phenol, phenylsalicylate, resorcinol monobenzoate, 2,4-di-t-butylphenyl-3′,5′-di-t-butyl-4′-hydroxybenzoate, and hexadecyl-3,5-di-t-butyl-4-hydroxybenzoate; substituted oxanilides, e.g., 2-ethyl-2′-ethoxyoxanilide and 2-ethoxy-4′-dodecyloxanilide; cyanoacrylates, e.g., ethykalpha.-cyano-.beta.,.beta.-diphenylacrylate and methyl-2-cyano-3-methyl-3-(p-methoxyphenyl)acrylate or mixtures thereof. A specific example of an ultraviolet light absorber that may be present is UV 234, which is a high molecular weight ultraviolet light absorber of the hydroxyl phenyl benzotriazole class. The UV light absorber, when present, can be present in the polymer composition in an amount ranging from about 0.1% by weight to about 2% by weight, such as in an amount ranging from about 0.25% by weight to about 1% by weight based on the total weight of the polymer composition.

In one embodiment, the polymer composition may also include a formaldehyde scavenger, such as a nitrogen-containing compound. Mainly, of these are heterocyclic compounds having at least one nitrogen atom as hetero atom which is either adjacent to an amino-substituted carbon atom or to a carbonyl group, for example pyridine, pyrimidine, pyrazine, pyrrolidone, aminopyridine and compounds derived therefrom. Advantageous compounds of this nature are aminopyridine and compounds derived therefrom. Any of the aminopyridines is in principle suitable, for example 2,6-diaminopyridine, substituted and dimeric aminopyridines, and mixtures prepared from these compounds. Other advantageous materials are polyamides and dicyane diamide, urea and its derivatives and also pyrrolidone and compounds derived therefrom. Examples of suitable pyrrolidones are imidazolidinone and compounds derived therefrom, such as hydantoines, derivatives of which are particularly advantageous, and those particularly advantageous among these compounds are allantoin and its derivatives. Other particularly advantageous compounds are triamino-1,3,5-triazine(melamine) and its derivatives, such as melamine-formaldehyde condensates and methylol melamine. Oligomeric polyamides are also suitable in principle for use as formaldehyde scavengers. The formaldehyde scavenger may be used individually or in combination.

Further, the formaldehyde scavenger can be a guanidine compound which can include an aliphatic guanamine-based compound, an alicyclic guanamine-based compound, an aromatic guanamine-based compound, a hetero atom-containing guanamine-based compound, or the like. The formaldehyde scavenger can be present in the polymer composition in an amount ranging from about 0.005% by weight to about 2% by weight, such as in an amount ranging from about 0.0075% by weight to about 1% by weight based on the total weight of the polymer composition.

Still another additive that may be present in the composition is a sterically hindered phenol compound, which may serve as an antioxidant. Examples of such compounds, which are available commercially, are pentaerythrityl tetrakis[3-(3,5-di-tert-butyl-4-hydroxyphenyl)propionate] (IRGANOX® 1010, BASF), triethylene glycol bis[3-(3-tert-butyl-4-hydroxy-5-methylphenyl)propionate] (IRGANOX® 245, BASF), 3,3′-bis[3-(3,5-di-tert-butyl-4-hydroxyphenyl)propionohydrazide] (IRGANOX® MD 1024, BASF), hexamethylene glycol bis[3-(3,5-di-cert-butyl-4-hydroxyphenyl)propionate] (IRGANOX® 259, BASF), and 3,5-di-tert-butyl-4-hydroxytoluene (LOWINOX® BHT, Chemtura). The above compounds may be present in the polymer composition in an amount ranging from about 0.01% by weight to about 1% by weight based on the total weight of the polymer composition.

In one embodiment, the polymer composition of the present disclosure contains significant amounts of antioxidant and other stabilizers. For example, the polymer composition can be formulated so as to contain one or more sterically hindered phenol compounds in an amount greater than about 0.3% by weight, such as in an amount greater than about 0.4% by weight, such as in an amount greater than about 0.45% by weight, and generally in an amount less than about 5% by weight, such as in an amount less than about 2% by weight. Including greater amounts of antioxidant can increase the thermal stability of the polymer composition. For example, when the polymer composition is exposed to a temperature of 160° C. for 12 hours, the polymer composition may experience a weight loss of only less than about 1% by weight, such as less than about 0.8% by weight, such as less than about 0.6% by weight, such as less than about 0.5% by weight.

Light stabilizers that may be present in addition to the ultraviolet light stabilizer in the composition include sterically hindered amines. Hindered amine light stabilizers that may be used include oligomeric compounds that are N-methylated. For instance, another example of a hindered amine light stabilizer comprises ADK STAB LA-63 light stabilizer available from Adeka Palmarole. The light stabilizers, when present, can be present in the polymer composition in an amount ranging from about 0.1% by weight to about 2% by weight, such as in an amount ranging from about 0.25% by weight to about 1% by weight based on the total weight of the polymer composition.

In addition to the above components, the polymer composition may also contain an acid scavenger. The acid scavenger may comprise, for instance, an alkaline earth metal salt. For instance, the acid scavenger may comprise a calcium salt, such as a calcium citrate. The acid scavenger may be present in an amount ranging from about 0.01% by weight to about 1% by weight based on the total weight of the polymer composition.

Any of the above additives can be added to the polymer composition alone or combined with other additives. In general, each additive is present in the polymer composition in an amount less than about 5% by weight, such as in an amount ranging from about 0.005% by weight to about 2% by weight, such as in an amount ranging from about 0.0075% by weight to about 1% by weight, such as from about 0.01% by weight to about 0.5% by weight based on the total weight of the polymer composition.

In one embodiment, the polymer composition is free of any nucleants that may increase the crystallinity of the polyoxymethylene polymer. For instance, the polymer composition may be free or contain no oxymethylene terpolymers, talc particles, or the like.

All the additives and components described above are incorporated into the polymer composition and can be melt blended with the polyoxymethylene polymer to produce the particles that make up the powder. In one embodiment, filler particles can be blended and mixed with the polymeric particles to form a mixture of particles. The filler particles can be added for various reasons such as to improve the mechanical properties of the article being formed. The filler particles may also further assist in providing dimensional stability to the polymer composition.

The filler material can be non-metallic or metallic. Examples of fillers include a metallic powder, metallic fibers, glass fibers, mineral fibers, mineral particles, glass beads, hollow glass beads, glass flakes, polytetrafluoroethylene particles, graphite, boron nitride, or mixtures thereof.

Clay minerals may be particularly suitable for use as non-metallic fillers. Examples of such clay minerals include, for instance, talc (Mg₃Si₄O₁₀(OH)₂), halloysite (Al₂Si₂O₅(OH)₄), kaolinite (Al₂Si₂O₅(OH)₄), illite ((K, H₃O)(Al, Mg, Fe)₂(Si,Al)₄O₁₀[(OH)_{2,}(H₂O)]), montmorillonite (Na, Ca)_{0.33}(Al, Mg)₂Si₄O₁₀(OH)_{2.}nH₂O), vermiculite ((MgFe, Al)₃(Al, Si)₄O₁₀(OH)_{2.}4H₂O), palygorskite ((Mg, Al)₂Si₄O₁₀(OH).4(H₂O)), pyrophyllite (Al₂Si₄O₁₀(OH)₂), etc., as well as combinations thereof. In lieu of, or in addition to, clay minerals, still other particulate fillers may also be employed. For example, other suitable silicate fillers may also be employed, such as calcium silicate, aluminum silicate, mica, diatomaceous earth, wollastonite, and so forth. Mica, for instance, may be a particularly suitable mineral for use in the present disclosure. There are several chemically distinct mica species with considerable variance in geologic occurrence but all have essentially the same crystal structure. As used herein, the term “mica” is meant to generically include any of these species, such as muscovite (KAl₂(AlSi₃)O₁₀(OH)₂), biotite (K(Mg,Fe)₃(AlSi₃)O₁₀(OH)₂), phlogopite (KMg₃(AlSi₃)O₁₀(OH)₂), lepidolite (K(Li,Al)₂₋₃(AlSi₃)O₁₀(OH)₂), glauconite (K, Na)(Al, Mg, Fe)₂(Si, Al)₄O₁₀(OH)₂), etc., as well as combinations thereof.

Fibers may also be employed as a non-metallic filler to further improve the mechanical properties. Such fibers generally have a high degree of tensile strength relative to their mass. For example, the ultimate tensile strength of the fibers (determined in accordance with ASTM D2101) is typically from about 1,000 to about 15,000 Megapascals (“MPa”), in some embodiments from about 2,000 to about 10,000 MPa, and in some embodiments, from about 3,000 to about 6,000 MPa. Examples of such fibrous fillers may include those formed from glass, carbon, ceramics (e.g., alumina or silica), aramids (e.g., Kevlar® marketed by E.I. DuPont de Nemours, Wilmington, Del.), polyolefins, polyesters, etc., as well as mixtures thereof. Glass fibers are particularly suitable, such as E-glass, A-glass, C-glass, D-glass, AR-glass, R-glass, S2-glass, etc., as well as combinations thereof. Other configurations of glass fillers include beads, flakes, and microspheres.

The volume average length of the fibers may be from about 5 to about 400 micrometers, in some embodiments from about 8 to about 250 micrometers, in some embodiments from about 10 to about 200 micrometers, and in some embodiments, from about 12 to about 180 micrometers. The fibers may also have a narrow length distribution. That is, at least about 70% by volume of the fibers, in some embodiments at least about 80% by volume of the fibers, and in some embodiments, at least about 90% by volume of the fibers have a length within the range of from about 5 to about 400 micrometers. The fibers may also have a relatively high aspect ratio (average length divided by nominal diameter) to help improve the mechanical properties of the resulting polymer composition. For example, the fibers may have an aspect ratio of from about 2 to about 50, in some embodiments from about 4 to about 40, and in some embodiments, from about 5 to about 20 are particularly beneficial. The fibers may, for example, have a nominal diameter of about 10 to about 35 micrometers, and in some embodiments, from about 15 to about 30 micrometers.

A polytetrafluoroethylene, such as polytetrafluroethylene particles, may also be blended with the powder composition. The polytetrafluoroethylene particles, for instance, can have an average particle size of less than about 15 microns, such as less than about 12 microns, such as less than about 10 microns, such as less than about 8 microns. The average particle size of the polytetrafluoroethylene particles is generally greater than about 0.5 microns, such as greater than about 1 micron, such as greater than about 2 microns, such as greater than about 3 microns, such as greater than about 4 microns, such as greater than about 5 microns. Average particle size can be measured according to ISO Test 13321.

In one embodiment, the polytetrafluoroethylene particles can have a relatively low molecular weight. The polytetrafluoroethylene polymer may have a density of from about 300 g/I to about 450 g/I, such as from about 325 g/I to about 375 g/I when tested according to ASTM Test D4895. The polytetrafluoroethylene particles can have a specific surface area of from about 5 m²/g to about 15 m²/g, such as from about 8 m²/g to about 12 m²/g when tested according to Test DIN66132. The melt flow rate of the polytetrafluoroethylene polymer can be less than about 3 g/10 min, such as less than about 2 g/10 min when tested according to ISO Test 1133 when carried out at 372° C. with a load of 10 kg.

Examples of metallic fillers that may be used include stainless steel, ferrous materials such as black iron oxide (Fe₃O₄), magnetite, carbonyl iron, copper, aluminum, nickel, permalloy, etc., as well as mixtures thereof. Particularly suitable are stainless steel fibers or powders, which may have a ferromagnetic content of about 90 wt. % or more, in some embodiments about 95 wt. % or more, and in some embodiments, from about 98 wt. % to 100 wt. %. Suitable stainless steel fillers include those comprised of a grade 300-series austenitic or grade 400-series ferritic or martensitic stainless steels, or combinations thereof, as defined by the American Iron and Steel Institute (AISI). Suitable commercially available magnetic fillers include those such as POLYMAG from Eriez Magnetics; Beki-Shield BUO8/5000 CR E, Beki-Shield BUO8/12000 CR E, and/or BU11/7000 CR E P-BEKRT from Bekaert; PPO-1200-NiCuNi, PPO-1200-NiCu, and/or PPO-1200-Ni from Composite Material; G30-500 12K A203 MC from Toho Carbon Fiber; INCOFIBER® 12K20 and/or INCOFIBER® 12K50 from Inco Special Products; Novamet Stainless Steel Flakes from Novamet Specialty Products.

When the metallic filler is in the form of particles, the mean particle size may be from about 0.5 microns to about 100 microns, in some embodiments from about 0.7 microns to about 75 microns, and in some embodiments, from about 1 micron to about 50 microns. In addition, the particles may have a mean particle size such that at least about 90% of the particles pass through a 150 mesh (105 microns), in some embodiments at least about 95%, and in some embodiments, at least about 98%. Stainless steel particles may have a mean particle size such that at least about 90% of the particles pass through a 325 mesh (44 microns), in some embodiments at least about 95%, and in some embodiments, at least about 98%. Likewise, when metallic flakes are employed, the flakes may have a thickness of from about 0.4 to about 1.5 microns, in some embodiments from about 0.5 to about 1 micron, and in some embodiments, from about 0.6 to 0.9 microns. In addition, the flakes may have a size such that at least about 85% of the particles pass through a 325 mesh (44 microns), in some embodiments at least about 90%, and in some embodiments, at least about 95%. Further, metallic fibers may also have a diameter of from about 1 micron to about microns, in some embodiments from about 2 to about 15 microns, and in some embodiments, from about 3 to about 10 microns. The fibers may also have an initial length of from about 2 to about 30 mm, in some embodiments from about 3 to about 25 mm, and in some embodiments from about 4 to about 20 mm.

The one or more fillers can be present in the particle mixture (polymer particles plus filler particles) in an amount greater than about 3% by weight, such as in an amount greater than about 5% by weight, such as in an amount greater than about 8% by weight, such as in an amount greater than about 10% by weight, such as in an amount greater than about 12% by weight, such as in an amount greater than about 15% by weight, and generally in an amount less than about 60% by weight, such as in an amount less than about 50% by weight, such as in an amount less than about 40% by weight, such as in an amount less than about 30% by weight, such as in an amount less than about 25% by weight, such as in an amount less than about 20% by weight.

In order to form a powder from the polymer composition of the present disclosure, in one aspect, the components of the polymer composition can be mixed together and then melt blended. For instance, the components can be melt blended in an extruder. Processing temperatures can vary depending upon the type of polyoxymethylene polymer chosen for use in the application. In one embodiment, processing temperatures can be from about 165° C. to about 200° C.

Extruded strands can be produced which are then pelletized. The pelletized compound can then be ground to a suitable particle size and to a suitable particle size distribution to produce a powder that is well suited for use in three-dimensional printing.

For example, any suitable hammermill or granulator may be used to produce the powder composition. In one embodiment, cryogenic grinding is used to produce particles having a relatively small size and a uniform particle size distribution. Cryogenic grinding, for instance, can produce a powder not only having a uniform size but also having particles that are approximately spherical in shape.

As described above, the polymer composition can be formulated so as to display dramatically improved dimensional stability in relation to the polyoxymethylene polymer by itself. Dimensional stability can be measured by determining mold shrinkage of a molded specimen in accordance with ISO Test 294-4, 2577. One or more dimensional stabilizing agents can be blended with the polyoxymethylene polymer such that shrinkage can be reduced by at least about 10%, such as at least about 15%, such as at least about 20%, such as at least about 25%, such as at least about 30%, such as at least about 35%, such as at least about 40%, such as at least about 45%, such as at least about 50% in relation to the shrinkage characteristics of the polyoxymethylene polymer tested by itself.

In general, the polymer composition can have a shrinkage of 3% or less, such as 2% or less, such as 1.5% or less, such as 1.3% or less, such as 1.1% or less, such as 0.9% or less.

The powder composition, in one embodiment, can be incorporated into a printer cartridge that is readily adapted for incorporation into a three-dimensional printer system. The printer cartridge can include a dispensing container contained within a housing. The dispensing container can be for feeding the powder composition into the three-dimensional printer system.

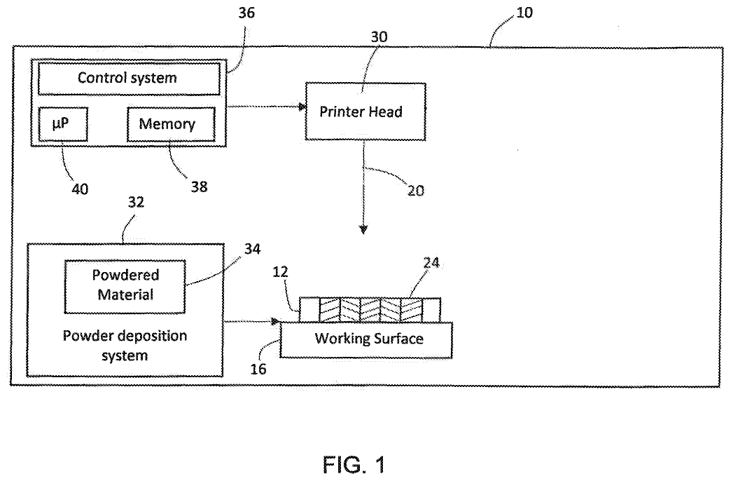

Generally speaking, any of a variety of three-dimensional printer systems can be employed in the present disclosure to produce three-dimensional articles. Referring to FIG. 1, for example, one embodiment of a fusion bed printing system is shown. The printing system 10 includes a working platform 16 that supports a layer of powder 12. The system 10 also includes a powder deposition system 32 that deposits a powder composition 34 made in accordance with the present disclosure on the working platform 16 to form the layer of powder 12.

The three-dimensional printing system 10 includes a printer head 30 that emits an energy source 20 onto the powder 12 and the working surface 16. The printer head 30, for instance, can include one or more lasers or other energy sources.

The printer head 30 is in communication with a control system 36 for controlling operation of the printer head. The control system 36 may include a distributed control system or any computer-based work station that is fully or partially automated. For example, the control system 36 can be any device employing a general-purpose computer or an application-specific device, which may generally include memory circuitry 38 storing one or more instructions for controlling operation of the printer head 30. The memory 38 can store CAD designs that control the formation of a three-dimensional article on the working surface 16. The control system 36 can include one or more processing devices, such as a microprocessor 40. The memory circuitry 38 may include one or more tangible, non-transitory, machine-readable media collectively storing instructions executable by the processing device 40 to enable the production of three-dimensional articles using the printer head 30.

As shown in FIG. 1, during the printing process, the powder 12 is heated to a molten state. The individual particles fuse or sinter together. In addition, the three-dimensional article is formed in a layer-by-layer manner wherein each successive layer thermally bonds together.

As described above, in one embodiment, the powder 12 is deposited onto the working platform 16. The layer of particles is then combined with a fusing agent that is selectively applied in a particular pattern. Optionally, a detailing agent can also be applied to the particles according to a pattern. After the powder, fusing agent, and detailing agent are applied, energy can then be applied to cause a layer of the article to be formed.

Articles made according to the present disclosure can offer various unique properties and characteristics. For example, articles made according to the present disclosure can generally have a relatively high density. In one aspect, articles made from the powder composition of the present disclosure can have a density of greater than about 1.2 g/cm³, such as greater than about 1.25 g/cm³, such as greater than about 1.3 g/cm³. The density is generally less than about 2 g/cm³, such as less than about 1.6 g/cm³. In addition to having a relatively high density, polymer products and articles made according to the present disclosure can also display, in one aspect, a relatively high tensile modulus. The tensile modulus, for instance, can be greater than about 2000 MPa, such as greater than about 2100 MPa, such as greater than about 2200 MPa, such as greater than about 2300 MPa, such as greater than about 2400 MPa, and generally less than about 4000 MPa. The tensile modulus, however, can be varied and lowered depending upon the particular components contained within the composition.

In order to manipulate the molten polymer material as the article is being formed and in order to ensure that the adjacent layers bond together, the polymer composition optimally has an enlarged operating window. In this regard, the one or more dimensional stabilizing agents of the present disclosure can not only provide dimensional stability but can also improve the operating window of the polyoxymethylene polymer. For instance, in one embodiment, the polymer composition of the present disclosure has a crystallinity temperature and has a melting temperature and wherein the difference between the melting temperature and the crystallinity temperature is at least 10° C., such as at least 12° C., such as at least 14° C., such as at least 16° C., such as at least 18° C., such as at least 20° C., such as at least 22° C., such as at least 24° C., such as at least 25° C., such as at least about 30° C., and generally less than about 50° C., such as less than about 40° C., such as less than about 35° C. For example, the polymer composition can have a melting temperature of less than about 185° C., such as less than about 180° C., such as less than about 175° C., such as less than about 170° C. and generally greater than 150° C. The polymer composition can also have a crystallinity temperature of greater than about 135° C., such as greater than about 140° C., such as greater than about 145° C., and generally less than about 150° C. As used herein, the melting temperature and the crystallinity temperature are the extrapolated onset temperatures for melting and crystallization determined according to ISO Test 11357 or 11357-1 (2016).

The present disclosure may be better understood with reference to the following examples.

### EXAMPLE NO. 1

Various polymer formulations were formulated and tested for various properties in order to demonstrate that powder compositions made from the formulations are well suited for three-dimensional printing.

More particularly, the following table includes the polymer compositions that were formulated and the physical properties that were obtained.

| | Sample | Sample | Sample | Sample | Sample |
|---|---|---|---|---|---|
| | No. 1 | No. 2 | No. 3 | No. 4 | No. 5 |
| Polyoxymethylene | 99.18 | | | | |
| Polymer | | | | | |
| (comonomer | | | | | |
| content 3.4 wt %, | | | | | |
| melt flow rate | | | | | |
| 46 cm³/10 min) | | | | | |
| Polyoxymethylene | | | | | 99.35 |
| Polymer | | | | | |
| (comonomer | | | | | |
| content 0.7 wt %, | | | | | |
| melt flow rate | | | | | |
| 2.1 cm³/10 min) | | | | | |
| Polyoxymethylene | | 98.95 | 99.35 | 79.35 | |
| Polymer | | | | | |
| (comonomer | | | | | |
| content 1.5 wt %, | | | | | |
| melt flow rate | | | | | |
| 13.7 cm³/10 min) | | | | | |
| Phenolic | 0.5 | 0.25 | 0.5 | 0.5 | 0.5 |
| antioxidant | | | | | |
| Ethylene | 0.15 | | 0.15 | 0.15 | 0.15 |
| copolymer, | | | | | |
| calcium acetate, | | | | | |
| Surlyn | | | | | |
| compatibilizer, | | | | | |
| Elvamide | | | | | |
| polyamide | | | | | |
| Calcium 12 | 0.07 | | | | |
| hydroxy stearate | | | | | |
| Allantoin | 0.1 | | | | |
| Polyoxymethylene | | | | 20 | |
| polymer | | | | | |
| Polyoxymethylene | | 0.5 | | | |
| terpolymer | | | | | |
| Ethylene | | 0.2 | | | |
| bisstearamide | | | | | |
| Tricalcium citrate | | 0.05 | | | |
| Copolyamide | | 0.05 | | | |
| Total (%) | | 100 | 100 | 100 | 100 |
| MI (ISO 1133) | 46 | 13.71 | 13.98 | 16.3 | 2.11 |
| KD | | 0 | 0.008 | 0.007 | 0.006 |
| Vol | | 0.063 | 0.098 | 0.063 | 0.01 |
| Flex modulus | 2509 | 2691 | 2539 | 2214 | 2468 |
| (Mpa) | | | | | |
| ISO 178 | | | | | |
| Flex strength | 66.6 | 71.97 | 66.53 | 58.39 | 64.6 |
| (Mpa) | | | | | |
| ISO 527-2/1A | | | | | |
| Tensile Modulus | 2721 | 2988.00 | 2754.00 | 2390.00 | 2631.00 |
| (MPa) | | | | | |
| ISO 527-2/1A | | | | | |
| Yield Stress | 62.91 | 67.58 | 65.29 | 59.31 | 64.68 |
| (MPa) | | | | | |
| ISO 527-2/1A | | | | | |
| Yield Strain (%) | 7.98 | 10.91 | 12.95 | 12.29 | 21.53 |
| ISO 527-2/1A | | | | | |
| Break Stress | | 63.2 | 64.1 | 51.45 | 62.2 |
| (MPa) | | | | | |
| ISO 527-2/1A | | | | | |
| Break Strain (%) | 17.72 | 31.23 | 22.97 | 51.4 | 46.69 |
| ISO 527-2/1A | | | | | |
| Charpy notched | 3.1 | 7.7 | 7.1 | 10 | 13.6 |
| (KJ/m²) | | | | | |
| ISO 179/1eA | | | | | |
| Unnotched | 90.4 | 226.5 | 257.1 | 271 | 239.8 |
| Charpy | | | | | |
| (KJ/m²) | | | | | |
| Process | 23.0 | 24.0 | 23.5 | 23.8 | 27.8 |
| Window | | | | | |
| (Tm-Tc) | | | | | |

### EXAMPLE NO. 2

In the following example, a polyoxymethylene copolymer was combined with various different dimensional stabilizing agents in order to demonstrate the improvements in shrinkage control. The polymer compositions were compared to a composition that only contained a polyoxymethylene polymer (Sample No. 6). The following polymer compositions were tested:
Sample No. 6: Polyoxymethylene copolymer having an MFR of 9 g/10 min.
Sample No. 7: Polyoxymethylene copolymer combined with 9% by weight of a thermoplastic polyurethane elastomer;
Sample No. 8: Polyoxymethylene copolymer combined with 18% by weight of a thermoplastic polyurethane elastomer;
Sample No. 9: Polyoxymethylene copolymer combined with 15% by weight glass fibers and 7% by weight high density polyethylene particles (4.5 million g/mol); and Sample No. 10: Polyoxymethylene copolymer combined with 15% by weight N-butylbenzene sulfonamide.

The above polymer compositions were tested for various physical properties and the following results were obtained:

| Sample No. | 6 | 7 | 8 | 9 | 10 | | |
|---|---|---|---|---|---|---|---|
| Physical properties | Value | Value | Value | Value | Value | Unit | Test |
| | | | | | | | Standard |
| ISO | | | | | | | |
| Density | 1410 | 1380 | 1360 | 1460 | 1350 | kg/m³ | ISO 1183 |
| Melt volume rate, MVR | 8 | 5.5 | 4 | 1.1 | 2 | cm³/10 min | ISO 1133 |
| MVR temperature | 190 | 190 | 190 | 190 | 190 | ° C. | ISO 1133 |
| MVR load | 2.16 | 2.16 | 2.16 | 2.16 | 2.16 | kg | ISO 1133 |
| Molding shrinkage, parallel | 2.0 | 1.8 | 1.6 | 1.1 | 1.5 | % | ISO 294-4, |
| | | | | | | | 2577 |
| Molding shrinkage, normal | 1.9 | 1.6 | 1.5 | 0.9 | 1.6 | % | ISO 294-4, |
| | | | | | | | 2577 |
| Water Absorption, 23° C.-sat | 0.75 | 0.8 | 0.8 | — | 0.3 | % | ISO 62 |
| Humidity absorption, | 0.2 | 0.25 | 0.25 | — | — | % | ISO 62 |
| 23° C./50% RH | | | | | | | |

As shown above, the inclusion of a dimensional stabilizing agent dramatically improved the shrinkage properties of the polymer composition.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A powder composition for a three-dimensional printing system, the powder composition comprising:
a sinterable powder comprised of particles having a volume based median particle size of from about 1 micron to about 200 microns, the sinterable powder being flowable and being comprised of a polymer composition; and
wherein the polymer composition comprises a polyoxymethylene polymer in an amount greater than about 30% by weight, the polyoxymethylene polymer being blended with a dimensional stability agent, the polymer composition displaying a shrinkage of 1.5% or less when tested according to ISO Test 294-4, 2577.

2. A powder composition as defined in claim 1, wherein the dimensional stabilizing agent comprises an amorphous polymer or an elastomeric polymer.

3. A powder composition as defined in claim 1, wherein the dimensional stabilizing agent comprises a methacrylate butadiene styrene, a styrene acrylonitrile, a polycarbonate, a polyphenylene oxide, an acrylonitrile butadiene styrene, a methyl methacrylate, a polylactic acid, a copolyester elastomer, a styrene ethylene butylene styrene block copolymer, a thermoplastic vulcanizate, an ethylene copolymer or terpolymer, an ethylene propylene copolymer or terpolymer, a polyalkylene glycol, a silicone elastomer, an ethylene acrylate, a sulfonamide, a high density polyethylene polymer, or mixtures thereof.

4. A powder composition as defined in claim 1, wherein the dimensional stabilizing agent comprises a thermoplastic polyurethane elastomer, the thermoplastic polyurethane elastomer being present in the polymer composition in an amount from about 4% to about 40% by weight.

5. A powder composition as defined in claim 4, wherein the polymer composition further comprises a coupling agent.

6. A powder composition as defined in claim 1, wherein the polymer composition further contains a powder flow agent and wherein the powder flow agent comprises a metal salt of a carboxylic acid or a metal oxide.

7. A powder composition as defined in claim 6, wherein the metal salt of the carboxylic acid comprises a metal salt of a stearate, such as calcium stearate, and wherein the metal oxide comprises alumina or silica, the powder flow agent being present in the polymer composition in an amount from about 2% by weight to about 25% by weight.

8. A powder composition as defined in claim 1, wherein the particles of the sinterable powder have a particle size such that 80% of the particles have a size of less than about 50 microns.

9. A powder composition as defined in claim 1, wherein the polyoxymethylene polymer is present in the polymer composition in an amount greater than about 60% by weight and in an amount less than about 95% by weight.

10. A powder composition as defined in claim 1, wherein the polymer composition has a crystallinity temperature and has a melting temperature and wherein the difference between the melting temperature and the crystallinity temperature is at least 10° C.

11. A powder composition as defined in claim 10, wherein the difference between the melting temperature and the crystallinity temperature of the polymer composition is from about 10° C. to about 35° C.

12. A powder composition as defined in claim 1, wherein the polymer composition has a melting temperature and has a crystallinity temperature, and wherein the melting temperature is less than about 180° C. and the crystallinity temperature is greater than about 130° C.

13. A powder composition as defined in claim 1, wherein the powder composition comprises a mixture of particles, the powder composition containing particles comprised of the polymer composition combined with filler particles and wherein the filler particles comprise a metallic powder, metallic fibers, glass fibers, mineral fibers, mineral particles, glass beads, hollow glass beads, glass flakes, polytetrafluoroethylene particles, graphite, boron nitride, or mixtures thereof.

14. A powder composition as defined in claim 1, wherein the polyoxymethylene polymer comprises a polyoxymethylene copolymer having a comonomer content of greater than about 0.1% by weight and less than about 1.5% by weight.

15. A powder composition as defined in claim 1, wherein the particles have a volume based median particle size of from about 40 microns to about 60 microns.

16. A printer cartridge for a three-dimensional powder bed fusion printing system, the printer cartridge containing the powder composition as defined in claim 1.

17. A three-dimensional printing system comprising a three-dimensional printing device and the printer cartridge as defined in claim 16.

18. A three-dimensional article formed from the powder composition as defined in claim 1.

19. A three-dimensional article as defined in claim 18, wherein the article is formed by fusing and then sintering the sinterable powder.

20. A method for producing a three-dimensional article comprising selectively forming a three-dimensional structure from a polymer feed material, the polymer feed material comprising the feed material as defined in claim 1.
